(19) United States
(12) Patent Application Publication
(10) Pub. No.: US 2006/0091067 A1
(43) Pub. Date: May 4, 2006

(54) Methods for the removal of heavy metals

(75) Inventors: Yunying Fan, Poway, CA (US); James Edward Saenz, Kalamazoo, MI (US); Bing Shi, San Diego, CA (US); Jayaram Kasturi Srirangam, San Diego, CA (US); Shu Yu, San Diego, CA (US)

Correspondence Address: AGOURON PHARMACEUTICALS, INC., 10777 SCIENCE CENTER DRIVE, SAN DIEGO, CA, 92121, US

(73) Assignee: Agouron Pharmaceuticals, Inc.

(21) Appl. No.: 11/264,432

(22) Filed: Oct. 31, 2005

Related U.S. Application Data
(60) Provisional application No. 60/624,719, filed on Nov. 2, 2004.

(51) Int. Cl. B01D 39/00

(52) U.S. Cl. 210/502.1; 210/679; 210/688

(57) ABSTRACT

The present invention relates to novel compositions such as cysteine adsorbed on solid support media and trimercaptotriazine bound to silica gel, which are useful for the removal of heavy metals such as palladium from organic phases. The present invention also relates to methods of removing heavy metals by using these compositions.

### FIELD OF THE INVENTION

This application claims priority to U.S. Patent Application No. 60/624,719, filed Nov. 2, 2004, which is hereby incorporated by reference.

The present invention relates to compositions and to methods of using such compositions for the removal of heavy metals, such as palladium.

### BACKGROUND

Heavy metals such as palladium, nickel, tin, and copper are widely used in industrial synthetic processes for the preparation of a wide variety of chemical compounds. Such heavy metals are often used as catalysts in chemical reactions. Because of their tendency to form complexes with organic compounds, however, these metals often remain in relevant amounts in the final product. Because of obvious safety concerns, removal of heavy metals from reaction products is an important aspect of chemical synthesis. In the case of pharmacologically active compounds, or intermediates for the preparation of pharmacologically active compounds, removal of toxic heavy metals is particularly important.

Cysteine is a known palladium scavenger (WO 98/51646). Amino acids such as cysteine, however, typically have low solubility in organic solvents, which results in poor contact between the amino acids and heavy metals in the organic phase. Accordingly, amino acids such as cysteine are typically considered to be effective as heavy metal scavengers in aqueous solutions only. Trimercaptotriazine (TMT) is another known scavenger of heavy metals such as palladium. However, because of varying solubility in different organic solvents, the use of TMT as a heavy metal scavenger is limited to certain chemical reactions (see Rosso, et al. Organic Process Res. Dev. 1:311-314 (1997)).

Because of the current limitations in removing heavy metals from organic compounds, there is a need in the art for more efficient and more cost effective methods of heavy metal removal.

The discussion of the background to the invention herein is included to explain the context of the present invention. This is not to be taken as an admission that any of the material referred to was published, known, or part of the common general knowledge in any country as of the priority date of any of the claims.

### SUMMARY

The present invention relates to compositions useful for removing heavy metals from an organic phase. In one embodiment, the invention provides a composition comprising solid support media and cysteine adsorbed thereto. In particular the solid support media is selected from the group consisting of silica gel, silica alumina, alumina, clay, and carbon. Still more particularly, the solid support media is silica gel. Even more particularly, the solid support media is silica alumina. Even more particularly, the solid support media is alumina. Even more particularly, the solid support media is clay. Even more particularly, the solid support media is carbon. Still more particularly, the cysteine is L-cysteine. Still more particularly, the cysteine is D-cysteine. Still more particularly, the cysteine is D,L-cysteine.

In another embodiment, the invention relates to a composition comprising solid support media and cysteine adsorbed thereto, wherein the composition comprises cysteine in an amount that is 0.01% or greater of the weight of the solid support media. Even more particularly, the composition comprises cysteine in an amount that is 0.1% or greater of the weight of the solid support media. Still more particularly, the composition comprises cysteine in an amount that is 0.5% or greater of the weight of the solid support media. Still more particularly, the composition comprises cysteine in an amount that is 1.0% or greater of the weight of the solid support media. Still more particularly, the composition comprises cysteine in an amount that is 5.0% or greater of the weight of the solid support media. Still more particularly, the composition comprises cysteine in an amount that is from 1% to 50% of the weight of the solid support media. For example the composition comprises cysteine in an amount that is from 1% to 30% of the weight of the solid support media. Still more particularly, the composition comprises cysteine in an amount that is from 5% to 30% of the weight of the solid support media.

In a further embodiment, the present invention relates to a method for making cysteine-adsorbed solid support media comprising contacting a solid support media with a solution comprising cysteine, and drying the solid support media. More particularly, the volume of cysteine solution contacted with the solid support media is no greater than 400% of the inner pore volume of the solid support media. More particularly, the volume of cysteine solution contacted with the solid support media is no greater than 200% of the inner pore volume of the solid support media. Even more particularly, the volume of cysteine solution contacted with the solid support media is no greater than 150% of the inner pore volume of the solid support media. Even more particularly, the volume of cysteine solution contacted with the solid support media is no greater than 100% of the inner pore volume of the solid support media. Even more particularly, the volume of cysteine solution contacted with the solid support media is no greater than the incipient wetness volume of the solid support media. Still more particularly, the solid support media is silica gel. Still more particularly, the solid support media is alumina silica. Still more particularly, the solid support media is clay. Still more particularly, the solid support media is carbon. Still more particularly, the solid support media is silica gel. Still more particularly, the cysteine is L-cysteine. Still more particularly, the cysteine is D-cysteine. Still more particularly, the cysteine is D,L-cysteine.

In a further embodiment, the present invention relates to a composition prepared by any of the methods described above.

In another embodiment, the invention relates to a composition comprising silica gel bound to trimercaptotriazine (TMT). More particularly, the invention relates to a composition wherein TMT is bound to silica gel according to the following formula 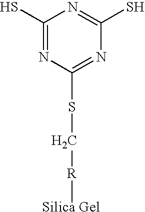
wherein R is C₁ to C₈ alkyl, C₂ to C₈ alkenyl, or C₂ to C₈ alkynyl. Even more particularly, R is ethyl.

In another embodiment, the invention relates to a composition comprising silica gel bound to TMT, wherein the composition comprises TMT in an amount that is 0.01% or greater of the weight of the silica gel. In a further embodiment the composition comprises TMT in an amount that is 0.1% or greater of the weight of the silica gel. Even more particularly, the composition comprises TMT in an amount that is 0.5% or greater of the weight of the silica gel. Still more particularly, the composition comprises TMT in an amount that is 1.0% or greater of the weight of the silica gel. Still more particularly, the composition comprises TMT in an amount that is 10% or greater of the weight of the silica gel. Still more particularly the composition comprises TMT in an amount that is 20%, 30%, 40%, 50%, 60%, 70%, or 80% of the weight of the silica gel.

In a further embodiment, the present invention relates to a method of binding TMT to silica gel comprising reacting a derivatized silica gel with TMT as follows 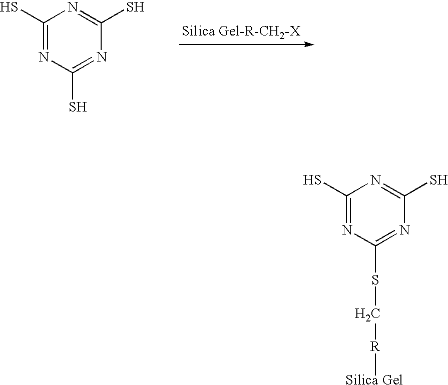
where R is C₁ to C₈ alkyl, C₂ to C₈ alkenyl, or C₂ to C₈ alkynyl and X is halogen. More particularly, R is ethyl and X is chlorine. Still more particularly, the reaction is carried out in the presence of a base, an organic solvent, and a salt. Even more particularly, the base is triethylamine, the organic solvent is methanol, and the salt is potassium iodide. TMT can exist as an un-ionized trithiol as shown above, a solid trisodium salt (TMT-Na₃, undecahydrate), and as an aqueous solution of TMT-Na₃. Accordingly, the present invention also relates to the TMT-Na₃ form bound to silica gel.

In another embodiment, the present invention relates to a composition prepared by the methods described above.

In a further embodiment, the invention relates to a method for reducing the amount of at least one heavy metal in an organic phase, the method comprising contacting the organic phase with any of the compositions described above to afford an organic phase wherein the amount of the at least one heavy metal is less than in the organic phase prior to contacting with said composition. More particularly, the contacting step is carried out by batch stirring. Still more particularly, the contacting step is carried out using a fixed bed reactor. Even more particularly, the amount of the at least one heavy metal in the organic phase after contacting with said composition is less than 1000 ppm. Even more particularly, the amount of the at least one heavy metal in the organic phase after contacting with said composition is less than 500 ppm. Even more particularly, the amount of the at least one heavy metal in the organic phase after contacting with said composition is less than 300 ppm. Even more particularly, the amount of the at least one heavy metal in the organic phase after contacting with said composition is less than 100 ppm. Even more particularly, the amount of the at least one heavy metal in the organic phase after contacting with said composition is less than 50 ppm. Even more particularly, the amount of the at least one heavy metal in the organic phase after contacting with said composition is less than 10 ppm. Even more particularly, the amount of the at least one heavy metal in the organic phase after contacting with said composition is less than 1 ppm. Even more particularly, the amount of the at least one heavy metal in the organic phase after contacting with said composition is not greater than the amount of said heavy metal allowed in pharmaceutical formulations by the U.S. Food and Drug Administration. Still more particularly, in any of the methods described above, the at least one heavy metal is palladium. Still more particularly, in any of the methods described above, the at least one heavy metal is tin. Still more particularly, in any of the methods described above, the at least one heavy metal is copper, platinum, silver, mercury, or lead.

In a further embodiment, the invention relates to a method for reducing the amount of at least one heavy metal in an organic phase, the method comprising contacting the organic phase with any of the compositions described above to afford an organic phase wherein the amount of the at least one heavy metal is reduced by at least 50% relative to the organic phase prior to contacting with said composition. More particularly, the amount of the at least one heavy metal is reduced by at least 70% relative to the organic phase prior to contacting with said composition. Still more particularly, the amount of the at least one heavy metal is reduced by at least 90% relative to the organic phase prior to contacting with said composition. Even more particularly, the amount of the at least one heavy metal is reduced by at least 95% relative to the organic phase prior to contacting with said composition.

Unless otherwise stated, the following terms used in the specification and claims have the meanings discussed below.

“Solid support media” refers to an insoluble material or particle which allows ready separation from liquid phase materials by filtration.

“L-cysteine” refers to the L stereoisomer of cysteine.

“D-cysteine” refers to the D stereoisomer of cysteine.

“D,L-cysteine” refers to a mixture of D and L stereoisomers of cysteine.

“Cysteine-adsorbed solid support media” refers to a solid support media comprising cysteine adsorbed thereto.

“Inner pore volume” refers to the interior cumulative open volume that results from pores or gaps found in various solid support media.

“Alkyl” refers to a saturated aliphatic hydrocarbon radical including straight chain and branched chain groups. Examples of alkyl groups include methyl, ethyl, propyl, 2-propyl, n-butyl, iso-butyl, tert-butyl, pentyl, and the like.

The term “C₂-C₈ alkenyl”, as used herein, means an alkyl moiety comprising 2 to 8 carbons having at least one carbon-carbon double bond. The carbon-carbon double bond in such a group may be anywhere along the 2 to 8 carbon chain that will result in a stable compound. Such groups include both the E and Z isomers of said alkenyl moiety. Examples of such groups include, but are not limited to, ethenyl, propenyl, butenyl, allyl, and pentenyl.

As used herein, the term “C₂-C₈ alkynyl” means an alkyl moiety comprising from 2 to 8 carbon atoms and having at least one carbon-carbon triple bond. The carbon-carbon triple bond in such a group may be anywhere along the 2 to 8 carbon chain that will result in a stable compound. Examples of such groups include, but are not limited to, ethyne, propyne, 1-butyne, 2-butyne, 1-pentyne, 2-pentyne, 1-hexyne, 2-hexyne, and 3-hexyne.

“Halogen” and/or “halide” refer to fluorine, chlorine, bromine or iodine.

“Organic phase” refers to a phase that is immiscible with an aqueous phase.

“Heavy metal” refers to any element in a block of the periodic table defined by Groups 3 to 16 and Periods 4 and higher.

### BRIEF DESCRIPTION OF THE DRAWINGS

FIG. 1 shows a schematic diagram of a heavy metal removal process using a fixed-bed reactor.

FIG. 2 shows a comparison of the UV-vis signal during the palladium removal process using a fixed-bed reactor. The feed concentration was kept constant.

FIG. 3 shows the profiles of palladium concentration as a function of recirculation time in the fixed-bed reactor process when 5 equivalents of silca gel were used.

### DETAILED DESCRIPTION

In order to improve the efficiency and cost effectiveness of heavy metal removal by cysteine in organic solvents, the present invention provides a composition comprising solid support media and cysteine adsorbed thereto. To overcome the problems associated with low solubility of cysteine in organic solvents when removing heavy metals, adsorbing cysteine to a solid support media such as silica gel was contemplated. Use of a solid support also facilitates separation of the heavy metal from the organic phase, as opposed to other separation procedures such as extraction. The present invention relates to the discovery that when a heavy metal scavenger such as cysteine is adsorbed uniformly to a solid support media, the surface area of exposed cysteine can be maximized. This cysteine-adsorbed solid support media can then be contacted with an organic phase containing at least one heavy metal, which subsequently allows greater contact between cysteine and a heavy metal, despite the low solubility of cysteine in the organic phase. Thus, use of this cysteine-adsorbed solid support media is able to improve the efficiency and cost-effectiveness of the heavy metal removal process.

The compositions of the present invention can be prepared using a variety of solid support media. Suitable solid support media are known to those of skill in the art and include those that are made of an inert inorganic matrix, which eliminates issues associated with swelling and solvent incompatibility. Suitable solid support media should also be amenable to drying and filtering from the organic phase. Use of a suitable solid support media is desirable since it can be added directly to the reaction mixture or used in a column to selectively remove heavy metals. Use of solid support media in this way also helps ensure that the process will be scalable without protocol modifications. Examples of suitable solid support media are known to those skilled in the art and include, but are not limited to, silica gel, silica alumina, alumina, clay, zeolites, titania, zirconia sulfate, alumino-phosphate, and carbon, which are all readily available from commercial sources. Silica gel involves a solid amorphous silicic acid which is known for use as an adsorption agent for gas, vapor and liquids and can be made with pores of different diameter. Silica gels exhibit a large inner surface, which may range up to 800 m²/g, to absorb liquid. Numerous grades of silica gel of varying mesh and pore size are commercially available and are known to those in the art. For example, Merck 10180 is a 70-230 mesh silica gel with a mean pore diameter of 40 angstroms. Merck 10184 is a 70-230 mesh silica gel with a mean pore diameter of 100 angstroms. Merck 10185 is a 35-70 mesh silica gel with a mean pore diameter of 100 angstroms. Merck 10181 is a 35-70 mesh silica gel with a mean pore diameter of 40 angstroms. Davisil 643 is a 200425 mesh silica gel with a mean pore diameter of 150 angstroms.

Although any type of silica gel can be used within the context of the present invention, preferred grades of silica gel include those that are less brittle such as Merck 10180. Numerous grades of silica alumina are also known to those in the art and are commercially available. For example, silica alumina grade 135 is available from commercial suppliers such as Aldrich. Clays suitable as solid support media are also known to those in the art and consist of layered materials with spaces between the layers that can absorb water molecules or positive and negative ions and undergo exchange interaction of these ions with solvents. Clays have very unique properties. When they are dried, for example, the molecules or ions between the layers can come out, the gaps between the layers can close and the layer stack can shrink significantly. Examples of clays include, but are not limited to laponite, bentonite or hectorite. Other suitable solid support media such as alumina, zeolites, titania, zirconia sulfate, alumino-phosphate, and carbon are well known to those in the art.

The amount of cysteine adsorbed to the solid support media can vary from certain lower limits to certain upper limits, where the amount of cysteine adsorbed to the solid support media can be stated in terms of a weight percentage of the weight of solid support media. This amount of cysteine adsorbed to the solid support media is also referred to as the loading percentage. The present invention contemplates a lower limit of cysteine loading of 0.01%, or 0.1%, or 0.5%, or 1%. For example, if 10.0 g of silica gel is used as the solid support media, the contemplated lower limits of cysteine adsorbed thereto would correspond to 0.001 g, 0.01 g, 0.05 g, or 0.1 g, respectively. The present invention also contemplates an upper limit of cysteine loading of 100%, or 50%, or 40%, or 30%, or 20%, or 10%. Again, for example, if 10.0 g of silica gel is used as the solid support media, the contemplated upper limits of cysteine adsorbed thereto would correspond to 10.0 g, 5.0 g, 4.0 g, 3.0 g, 2.0 g, or 1.0 g, respectively. Furthermore, the invention contemplates cysteine adsorbed on the solid support media in an amount that ranges from any of the above lower limits to any of the above upper limits. The optimal loading of cysteine on a particular solid support media will vary depending on the chemical species involved and the specific treatment procedure that is used.

Cysteine exists in two different stereoisomers, designated as D-cysteine and L-cysteine. Accordingly, cysteine can exist as either relatively pure D-cysteine, relatively pure L-cysteine, or a mixture of the two isomers, which can be designated as D,L-cysteine. When cysteine is adsorbed to silica gel and used to remove palladium from an organic phase, there is an insignificant difference in the removal efficiency between L-cysteine and D,L-cysteine. Accordingly, since L-cysteine is significantly cheaper than D,L-cysteine, use of L-cysteine provides a more cost effective means to reduce levels of palladium in an organic phase.

The process of coating onto porous solid support media is mechanistically complex. Several factors can influence the coating process, including the solid support surface area, the structure and composition of the solid support media, the temperature, the concentration of the chemical species being adsorbed thereto, and the drying conditions (see, e.g. Ertl et al., Handbook of Heterogeneous Catalysis, John Wiley & Sons, (April 1997); Ruiz et al. Separation Science and Technology 37:2143 (2002)). Challenges associated with adsorbing to a porous solid media include inconsistent loading from batch to batch, structural changes to the solid support media (e.g. surface area, pore volume), aggregation, and non-uniform coating. One embodiment of the present invention relates to a method for making cysteine-adsorbed solid support media comprising contacting a solid support media with a solution comprising cysteine, and then drying the solid support media.

Several methods of contacting the cysteine with the solid support media are contemplated in the present invention. For example, one method known as evaporation coating involves adding a solution of cysteine to a fixed vessel that contains the solid support media followed by stirring. This mixture is then dried with heating conditions under vacuum. Another coating procedure known as precipitation coating involves adding a cysteine solution to a fixed vessel that contains the solid support media, followed by stirring. A cysteine precipitating agent, such as an organic solvent, is then added to the mixture, which causes any non-adsorbed cysteine to precipitate. The slurry is then filtered and the wet cake is dried using heating conditions under vacuum.

Another method of contacting the cysteine solution with the solid support media is known as impregnation coating. This method involves contacting the solid support media with a cysteine solution by wetting the solid support media through diffusion. This can be accomplished, for example, by adding a volume of cysteine solution that is equal to the incipient wetness volume of the solid support media to a fixed vessel containing the solid support media. Because the adsorbtion of cysteine to the solid support media is accomplished primarily through diffusion, stirring or mixing is not necessary. The resulting impregnated solid support media can then be dried using heating conditions under vacuum.

The amount of cysteine solution that is contacted with a solid support media using the impregnation method can be stated in terms of the incipient wetness volume of the solid support media. The incipient wetness volume is specific for each solid support media, and can vary depending on several factors including the manufacturing procedure. For a particular solid support media, the incipient wetness volume indicates the amount of solution required to saturate the inner pore volume. The incipient wetness volume of a given solid support media can be determined by measuring the minimum amount of solution required to be added to the solid support media so that a paste is formed. The incipient wetness volume is typically 50 to 70% greater than the inner pore volume of the solid support media.

In one embodiment of the invention is a method for making cysteine-adsorbed solid support media by contacting the solid support media with an amount of cysteine solution that is not greater than 200% of the inner pore volume. For example, silica gels typically have an inner pore volume ranging from 0.5 to 1.5 mL/g. For example, if the inner pore volume of a particular silica gel is 0.7 mL/g, cysteine solution would be contacted with 1.0 g of the silica gel in an amount not greater than 1.4 mL. Similarly, another aspect of the invention is a method for making cysteine-adsorbed solid support media by contacting the solid support media with an amount of cysteine solution that is not greater than 150% of the inner pore volume. Using 1.0 g of the same silica gel as above with a corresponding inner pore volume of 0.7 mL/g, cysteine solution would be contacted with 1.0 g of the silica gel in an amount not greater than 1.05 mL.

Once the cysteine solution has been contacted with the solid support media, the resulting mixture can be dried to remove any liquid medium. The present invention contemplates any suitable means of drying. Suitable drying conditions usually comprise an elevated temperature and/or a reduced pressure. In general, techniques for drying are known in the art, including heating to promote evaporation of the liquid medium, or simply drying in air. The drying step generally removes a significant portion of the liquid medium from the mixture; however, there still may be a minor portion (e.g., 10% or less by weight) of the liquid medium present in the dried mixture. Typical drying conditions include temperatures ranging from room temperature to over 200° C., typically between 50° C. to 150° C. The amount of time for drying to occur may range from about 30 minutes to more than several days. Suitable methods of drying and corresponding equipment are well known to those of skill in the art. Examples of such suitable means of drying include, but are not limited to, drying in a pan oven under vacuum, use of an agitated dryer, use of a tumble dryer, or use of a rotary evaporator.

When adsorbing cysteine on silica gel on small scales (e.g. less than 5 g silica gel) a vacuum pan dryer provides sufficient drying conditions. Furthermore, movement of the silica gel is generally not required due to the uniform heating in the small sample size. At larger scales (e.g. 50 g or more silica gel), however, movement of the silica gel is generally necessary to prevent cysteine/water channeling between particles. A rotary evaporator or tumble dryer can be used at large scales to avoid such problems. These types of drying not only help ensure a uniform distribution of cysteine on silica gel, but can also reduce the drying time due to better heat and mass transfer compared with a pan dryer.

In the methods discussed above, the cysteine solution can be an aqueous solution. The cysteine solution can also contain HCl, which is useful to prevent the oxidation of cysteine to cystine. For example, the cysteine solution can be a 0.01 N HCl solution. The concentration of cysteine in the solution can vary depending on the incipient wetness volume of the solid support media being used and the desired cysteine loading percentage on the solid support media. For example, if a 10% cysteine loading on silica gel is desired, given the amount of silica gel to be used, and the corresponding incipient wetness volume, the cysteine concentration can be adjusted to the appropriate level in order to achieve a 10% loading. To dissolve cysteine in water, the temperature can be increased from room temperature to 50° C. and stirred until cysteine is dissolved. During stirring, the solution can be sealed or kept under an inert atmosphere to prevent oxidation of cysteine. As discussed previously, cysteine can exist as either D-cysteine, L-cysteine, or a mixture of the two isomers, which can be designated as D,L-cysteine. Once the cysteine has been adsorbed onto the solid support media, it should be stored at room temperature in a sealed container.

The present invention also relates to a composition comprising trimercaptotriazine (TMT) bound to silica gel. Because of the varying solubility of TMT in different solvents, binding TMT to a solid support media such as silica gel provides improved contact with heavy metals, regardless of the solvent systems being used. TMT can be bound to silica gel through a linker as shown in the following structure 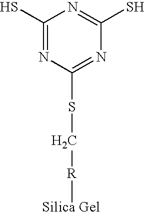
wherein R is C₁ to C₈ alkyl, C₂ to C₈ alkenyl, or C₂ to C₈ alkynyl, including straight chain and branched chain groups. Examples include, but are not limited to, methyl, ethyl, propyl, butyl, pentyl, isobutyl, tert-butyl, ethenyl, propenyl, butenyl, allyl, pentenyl, ethyne, propyne, 1-butyne, 2-butyne, 1-pentyne, 2-pentyne, 1-hexyne, 2-hexyne, and 3-hexyne. TMT is commercially available as the un-ionized trithiol, as a solid trisodium salt (TMT-Na₃, undecahydrate), and as an aqueous solution of TMT-Na₃. Thus, TMT-Na₃ can also be bound to silica gel in a manner analogous to that shown above for TMT.

TMT or TMT-Na₃ can be bound to silica gel by reacting a derivatized silica gel with TMT or TMT-Na₃, according to the following reaction scheme: 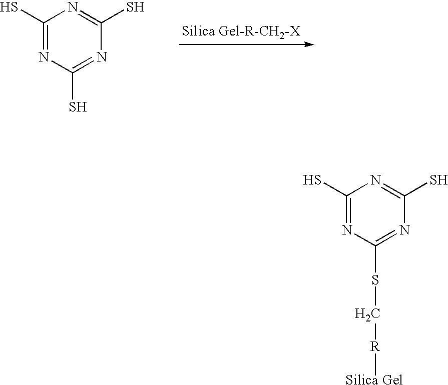
where R and X are as defined above. In particular, alkyl-halide silica gels such as chloride-3 silica gel (Silicycle) are commercially available. The binding reaction can take place under conditions that include a base, an organic solvent, and a salt. Suitable bases include bases with a pKa greater than 7. Typical bases include but are not limited to potassium carbonate, sodium carbonate, cesium carbonate, cesium hydroxide, sodium tert-butoxide, potassium tert-butoxide, potassium phenoxide, cyclohexylamine, diisopropylethylamine, trimethylamine, triethylamine, and the like, or mixtures thereof. Suitable organic solvents include alcohols such as ethanol and methanol, dimethyl formamide, acetonitrile, tetrahydrofuran, toluene, xylenes, dimethylethyleneglycol, and the like, or mixtures thereof. Suitable salts include any iodine salt, such as potassium iodine. Other appropriate general reaction conditions, which are well known to those of skill in the art, may include stirring, heating to reflux, stirring at reflux under nitrogen atmosphere, and cooling.

The amount of TMT bound to silica gel can vary from certain lower limits to certain upper limits, where the amount of TMT bounded to silica gel can be stated in terms of a weight percentage of the weight of silica gel. This amount of TMT bound to the silica gel is also referred to as the loading percentage. The present invention contemplates a lower limit of TMT loading of 0.01%, or 0.1%, or 0.5%, or 1%. For example, if 10.0 g of silica gel is used, the contemplated lower limits of TMT bound thereto would correspond to 0.001 g, 0.01 g, 0.05 g, or 0.1 g, respectively. The present invention also contemplates an upper limit of TMT loading of 100%, or 50%, or 40%, or 30%, or 20%, or 10%. Again, for example, if 10.0 g of silica gel is used, the contemplated upper limits of TMT bound thereto would correspond to 10.0 g, 5.0 g, 4.0 g, 3.0 g, 2.0 g, or 1.0 g, respectively. Furthermore, the invention contemplates TMT bound to silica gel in an amount that ranges from any of the above lower limits to any of the above upper limits. The optimal loading of TMT on a particular silica gel will vary depending on the chemical species involved and the specific treatment procedure that is used.

The compositions described above can be used to reduce the amount of at least one heavy metal in an organic phase. This can be done by contacting the organic phase with any of the cysteine-adsorbed solid support media or TMT-CH₂—R-silica gel compositions described herein. Contacting the cysteine-adsorbed solid support media or TMT-CH₂—R-silica gel compositions with the organic phase can be done using any suitable method that allows these compositions to come into contact with the organic phase. Examples of this contacting step include, but are not limited to, batch stirring and use of a fixed bed reactor. The process of batch stirring is well known and involves adding the components to be contacted with each other to a constant volume vessel, followed by any suitable means of stirring. Addition of the components can be done simultaneously or individually in any order. Components that are added to the vessel in a batch stirring process remain in the vessel until the reaction is complete. Use of fixed-bed reactors to contact various components is also well known to those in the art and involves passing a first component through a column containing a second component. The first component is allowed to enter and then exit the column, while the second component remains in the column throughout the reaction process. Several types of fixed-bed reactors are well known, and include tube reactors and shell-and-tube reactors. The terms “tube reactor” and “shell-and-tube reactor” refer to parallel assemblies of many channels in the form of tubes, where the tubes can have any cross section. The tubes are fixed in space relative to one another, preferably have a spacing between them, and are preferably surrounded by a jacket (shell) which encloses all the tubes. In this way, for example, a heating or cooling medium can be passed through the shell so that all tubes are uniformly heated/cooled. Cooling mediums that can be used in such fixed-bed reactors include water, or a mixture of ethylene glycol and water. For example, a mixture of 30% ethylene glycol and water can be used for cooling purposes.

By employing the methods described above, the level of heavy metal in an organic phase can be reduced. For example, the level of a heavy metal can be reduced to an amount that is less than 500 ppm, less than 300 ppm, less than 100 ppm, less than 10 ppm, or less than 1 ppm. Heavy metals that can be reduced by employing these methods include palladium, copper, tin, platinum, silver, mercury and lead. The level of reduced heavy metal in an organic phase will depend on several factors including the concentration of heavy metal originally present in the organic phase, the contact time between the organic phase and the compositions for removal of heavy metals described herein, the volume of the treated organic phase, the method of contacting (e.g. use of a fixed bed reactor, or batch stirred), the loading of the heavy metal scavenger on the solid support media, and the amount of loaded solid support media used. One of skill in the art will recognize that the above reaction conditions can be modified to achieve different levels of reduced heavy metal in an organic phase.

Regulatory agencies, such as the U.S. Food and Drug Administration (USFDA), often require levels of specific heavy metals to be below certain upper limits in food, pharmaceutical formulations, or other substances that humans can be exposed to. Levels of heavy metals that are acceptable in a pharmaceutical drug substance can have significant variation, depending on factors such as the dosage, mode of administration, treatment population and duration of treatment, known toxicity of the metal in question, and the ability of manufacturing processes to control the heavy metal levels. The most common test for heavy metal levels is described in the U.S. Pharmacopoeia (USP), with similar methods reported in the European Pharmacopoeia (EP) and Japan Pharmacopoeia (JP). By employing the methods described above, the level of heavy metal in an organic phase can be reduced to an amount that is not greater than the amount of said heavy metal allowed by a regulatory agency such as the USFDA. Allowable levels of specific heavy metals for specific situations and conditions are published and are readily available from the various regulatory agencies.

### EXAMPLES

In the examples described below, unless otherwise indicated, all temperatures are in degrees Celsius (° C.), and all parts and percentages are by weight. Various starting materials and other reagents were purchased from commercial suppliers such as Aldrich Chemical Company and EM science, and were used without further purification, unless otherwise indicated.

The examples and preparations provided below further illustrate and exemplify the methods and compositions of the present invention. It should be understood that the scope of the present invention is not limited in any way by the scope of the following examples.

As used in the examples below, TMT refers to trimercaptotriazine, DCM refers to dichloromethane, ACN refers to acetonitrile, MeOH refers to methanol, Ac refers to acetyl, THF refers to thetrahydrofuran, min refers to minutes, ppm refers to parts per million, and vol refers to volume.

### Example 1

### Process for the Preparation of 10% Cysteine on Silica Gel

Silica gel with a cysteine loading of 10% was prepared according to the following procedure. 3000 g of Merck 10180 silica gel (70-230 mesh; mean pore diameter 40 angstroms; surface area 692 m²/g; pore volume 0.724 mL/g; incipient wetness volume 1.18 mL based on 1.1 g sample) were added to a 22 L Rotovap rotary evaporator while rotating. A solution of L-cysteine (300 g) in water (3300 mL) was then added to the rotary evaporator. The resulting mixture was evaporated under house vacuum (approx. 65 mbar) at a bath temperature of 50° C. The silica gel was continued drying for 24 hours, or until the moisture content as measured by a Mettler Toledo Karl Fisher titrator (DL31) was <4%.

### Example 2

### Process for Palladium Removal Treatment

To test the cysteine-adsorbed silica gel as prepared in Example 1, a palladium contimainted organic phase, resulting from the following chemical reaction, was used. 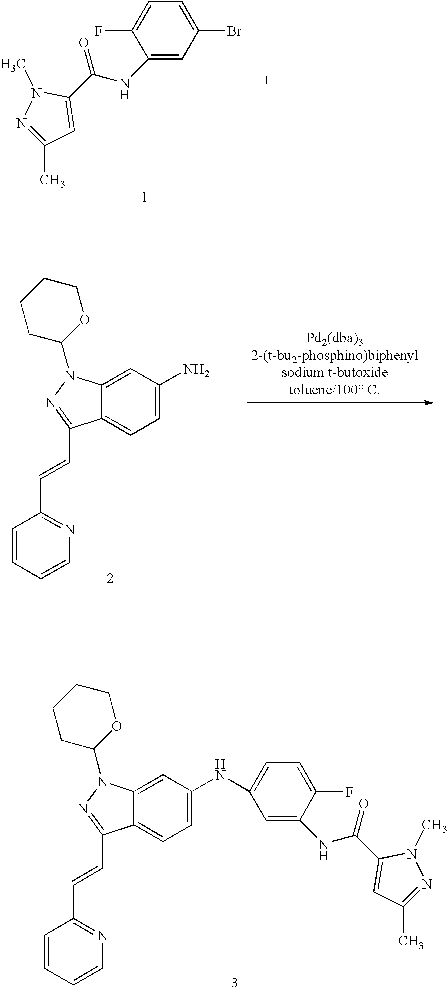
The reaction shown above is a reaction step discussed in detail in a U.S. provisional patent application entitled Methods for Preparing Indazole Compounds, U.S. 60/624,801 filed on Dec. 14, 2004, which is incorporated herein by reference. To carry out the above reaction, a 2 L three-neck flask, equipped with a mechanical stirrer, temperature probe, and condenser, was charged with compound 1 (48.8 g), compound 2 (50.0 g), di-t-butylphosphinobiphenyl (2.42 g), sodium t-butoxide (19.30 g), and toluene (500 mL) under argon atmosphere. The resulting slurry was evacuated and backfilled with argon. The evacuation backfill procedure was repeated three times. The flask was then charged with tris(dibenzylideneacetone) dipalladium under a blanket of argon. The reaction mixture was then heated to reflux (102° C.) and stirred for 18 hours under argon. The reaction was monitored by HPLC. After 18 hours, HPLC indicated 10.78% @ 4.69 min (compound 2), 5.11% @ 5.34 min (compound 1), 26.85% @ 5.97 min (toluene), and 49.09% @ 6.15 min (compound 3). Due to the use of the palladium catalyst, the final compound 3 showed a palladium content of 5000 ppm. To reduce the level of palladium, the reaction was allowed to cool to 40° C., then charged with THF (500 mL), followed by 10% cysteine-adsorbed silica gel (250 g) as prepared in Example 1. The resulting mixture was stirred at room temperature for 24 hours. The mixture was then filtered through a course-fritted funnel with a pad of Celite™ 545 (100 g). The resulting pad was washed with THF (500 mL). A sample from the combined filtrate was found to have 530 ppm palladium. HPLC analysis following the cysteine-adsorbed silica gel treatment indicated 12.28% @ 4.19 min (compound 2), 7.56% @ 4.88 min (compound 1), 58.95% @ 5.83 min (compound 3), and 8.72% @ 6.84 min (unknown). The combined filtrate was concentrated leaving 1000 mL of solution that was stirred with 10% cysteine-adsorbed silica gel (250 g) for 48 hours. The mixture was filtered through a course-fritted funnel with a pad of Celite™ 545 (100 g). The resulting pad was rinsed with THF (1000 mL). The combined filtrate was concentrated leaving 75.67 g of yellow foam of compound 3. The sample was found to contain 92 ppm palladium. HPLC following this second treatment with cysteine-adsorbed silica gel indicated 13.37% @ 4.68 min (compound 2), 6.96% @ 5.33 min (compound 1), 59.29% @ 6.14 min (compound 3), and 8.23% @ 6.95 min (unknown). The HPLC method used involved the following conditions: Phenomenex Prodigy ODS-3 column, 50×4.6 mm, 5 μm; UV detector, 254 nm; solvents used were 0.025 M aqueous NH₄OAc/ACN; gradient was 15-90% ACN over 5.25 min, hold 90% ACN 2.25 min; Flow rate was 1.0 mL/min; retention times were 4.69 min (compound 2), 5.34 min (compound 1), 5.97 min (toluene), and 6.15 min (compound 3).

### Example 3

### Process for the Preparation of 5% Cysteine on Silica Gel

Three different types of silica gel with a D,L-cysteine loading of 5% were prepared according to the following procedure. 5 g of the first type of silica gel (Merck Type 10180, with a inner pore volume of 0.724 mL/g) was wetted with 5.36 mL (the incipient wetness volume of Merck Type 10180 silica gel) of D,L-cysteine solution (0.25 g cysteine in 0.01N HCl). 5 g of the second type of silica gel (Merck Type 10181) was wetted with 8.5 mL (the incipient wetness volume of Merck Type 10181 silica gel) of D,L-cysteine solution (0.25 g cysteine in 0.01N HCl). 5 g of the third type of silica gel (Davisil 643) was wetted with 9.75 mL (the incipient wetness volume of Davisil 643 silica gel) of D,L-cysteine solution (0.25 g cysteine in 0.01N HCl). No external mixing was applied to the mixtures. Each silica gel was wetted completely by diffusion. The impregnated silica gels were then dried in a pan oven at 50° C. and full vacuum overnight. Using a polarized microscope, virtually no cysteine crystals were observed on any of the silica gels, indicating that aggregation of cysteine had not occurred during the adsorption process.

### Example 4

### Use Tests for Cysteine on Silica Gel Coated by the Impregnation Procedure

To test the cysteine-adsorbed silica gels as prepared in Example 3, a palladium contaminated organic phase, resulting from the following chemical reaction as described in Example 2, was used.

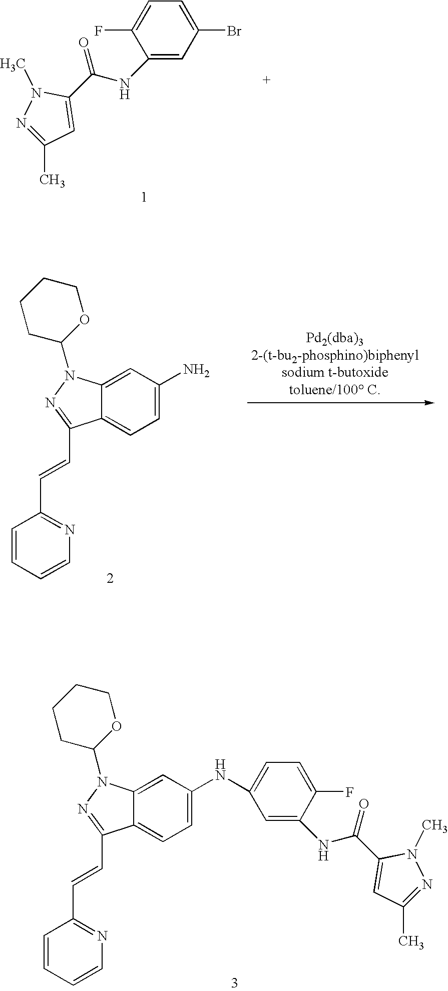

The reaction shown above is a reaction step discussed in detail in a U.S. provisional patent application entitled Methods for Preparing Indazole Compounds, U.S. 60/624,801, filed on Dec. 14, 2004, which is incorporated herein by reference. The coupling reaction shown above uses a palladium catalyst to couple compounds 1 and 2. Because palladium was used in the reaction step, the resulting compound 3 was contaminated with palladium (5000 ppm). About 200 mg of compound 3 was first dissolved in 25× volume THF in a flask. Several types of cysteine-adsorbed silica gel (shown in the table below and prepared as described in Examples 1 and 3) were each tested for their ability to reduce palladium levels. 5-weight equivalent of the silica gel (with 5% cysteine loading) was then added to the flask containing compound 3. The mixture was stirred in a sealed flask under room temperature overnight. The slurry was filtered using a Whatman™ 0.2 μm PTFE syringe filter. The liquid phase was then evaporated to dryness in a vacuum oven to yield the treated compound 3 for palladium content analysis. Measurement of the palladium content was performed using an inductively coupled plasma (ICP) analysis, performed by Galbraith Laboratory, Inc. (Knoxville, Tenn.). The results for each of the cysteine-adsorbed silica gels are shown in the following table.

| | | | Palladium | Palladium |
|---|---|---|---|---|
| | | | content | content |
| | | Amount of | before | after |
| | Cysteine | Compound | treatment | treatment |
| Silica Gel | Type | 3 (mg) | (ppm) | (ppm) |
| Merck 10180 | D, L | 205.0 | 5000 | 220 |
| Merck 10180 | D, L | 205.8 | 5000 | 280 |
| Merck 10180 | L | 207.2 | 5000 | 280 |
| Merck 10184 | D, L | 202.5 | 5000 | 218 |
| Davisil 643 | D, L | 207.9 | 5000 | 240 |

### Example 5

### Testing for Optimum Cysteine Loading

The efficiency of cysteine on silica gel can be influenced by its loading. For a certain compound and a certain treatment procedure, there will be a loading where the cysteine on silica gel reaches its optimum efficiency in removing heavy metals such as palladium. Silica gels with loading percentages ranging from 1 to 30% were used in the palladium removal process described in Example 4. The results, shown in the table below, indicate that a 5% cysteine loading is optimal for the particular compound (compound 3), and for the particular palladium removal treatment as described in Example 4. It should be noted that the optimal loading percentage can vary depending on the particular compound being treated and the particular treatment process that is used.

| | | | Palladium | Palladium |
|---|---|---|---|---|
| | | | Content | Content |
| Cysteine | | Amount of | Before | After |
| Loading | Cysteine | Compound | Treatment | Treatment |
| (%) | Type | 3 (mg) | (ppm) | (ppm) |
| 1 | L | 197.9 | 5000 | 410 |
| 3 | L | 205.6 | 5000 | 440 |
| 5 | L | 207.2 | 5000 | 280 |
| 5 | D, L | 205.8 | 5000 | 280 |
| 10 | L | 207.3 | 5000 | 451 |
| 10 | L | 501.4 | 5000 | 413 |
| 15 | D, L | 201.9 | 5000 | 360 |
| 30 | D, L | 200.7 | 5000 | 400 |

### Example 6

### Process for the Preparation of TMT-Silica Gel

Trimercaptotriazine (TMT) can be bound to silica gel according to the following reaction.

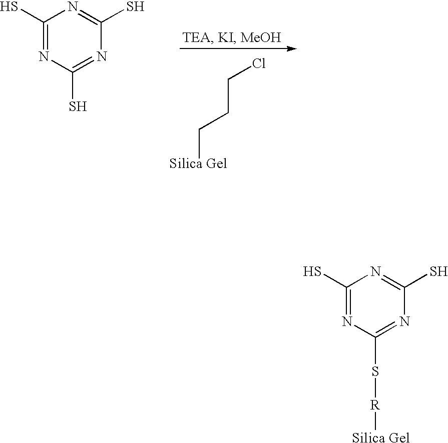

Four different procedures were used to prepare TMT-silica gel, labeled A-D. A) A 22 L three-neck flask equipped with a mechanical stirrer and a temperature probe was charged with MeOH (8000 mL), TMT (515 g), triethylamine (3750 mL), chloride-3 silica gel (1020 g, SiliCycle), and potassium iodide (240 g) while stirring under nitrogen atmosphere. The resulting slurry was stirred while heating to reflux (64° C.). The reaction was then stirred at reflux for 48 hours under nitrogen atmosphere. The heat was removed and the reaction was allowed to stir while cooling to 40° C. The mixture was filtered through course fritted filter under vacuum. The resulting solids were washed with THF (8L), 2N HCl (8L), water (4L), and then THF (4L). The solids were then transferred to a drying dish and dried under house vacuum for 48 hours at 40° C. B) A 22 L three-neck flask equipped with a mechanical stirrer and a temperature probe was charged with MeOH (5 vol/g chloride-3 silica gel), TMT (2.0 eq.), triethylamine (5 vol/g chloride-3 silica gel), chloride-3 silica gel (25.0 g, SiliCycle), and potassium iodide (1 eq.) while stirring under nitrogen atmosphere. The resulting slurry was stirred while heating to reflux (68° C.). The reaction was then stirred at reflux for 18 hours under nitrogen atmosphere. The heat was removed and the reaction was allowed to stir while cooling to room temperature. The mixture was filtered through course fritted filter under vacuum. The resulting solids were washed with 2N HCl (200 mL), then THF (400 mL). This washing procedure was repeated once. The resulting wet solids were then dried for 3 days at 22° C. under vacuum. C) A 22 L three-neck flask equipped with a mechanical stirrer and a temperature probe was charged with MeOH (7 vol/g chloride-3 silica gel), TMT (2.0 eq.), triethylamine (3 vol/g chloride-3 silica gel), chloride-3 silica gel (50.0 g, SiliCycle), and potassium iodide (1 eq.) while stirring under nitrogen atmosphere. The resulting slurry was stirred while heating to reflux (68° C.). The reaction was then stirred at reflux for 42 hours under nitrogen atmosphere. The heat was removed and the reaction was allowed to stir while cooling to room temperature. The mixture was filtered through course fritted filter under vacuum. The resulting solids were washed with THF (400 mL), 2N HCl (400 mL), then THF (400 mL). The resulting wet solids were then dried for 18 hours at 40° C. under vacuum. D) A 22 L three-neck flask equipped with a mechanical stirrer and a temperature probe was charged with MeOH (7 vol/g chloride-3 silica gel), TMT (2.0 eq.), triethylamine (3 vol/g chloride-3 silica gel), chloride-3 silica gel (200 g, SiliCycle), and potassium iodide (1 eq.) while stirring under nitrogen atmosphere. The resulting slurry was stirred while heating to reflux (68° C.). The reaction was then stirred at reflux for 42 hours under nitrogen atmosphere. The heat was removed and the reaction was allowed to stir while cooling to room temperature. The mixture was filtered through course fritted filter under vacuum. The resulting solids were washed with THF (1500 mL), 2N HCl (1500 mL), water (500 mL), then THF (1000 mL). The resulting wet solids were then dried for 60 hours at 40° C. under vacuum.

### Example 7

### Palladium Removal Using TMT-Slica Gel

To test the ability of the TMT-silica gels as described in Example 6, a palladium contaminated organic phase, resulting from the following chemical reaction, was used.

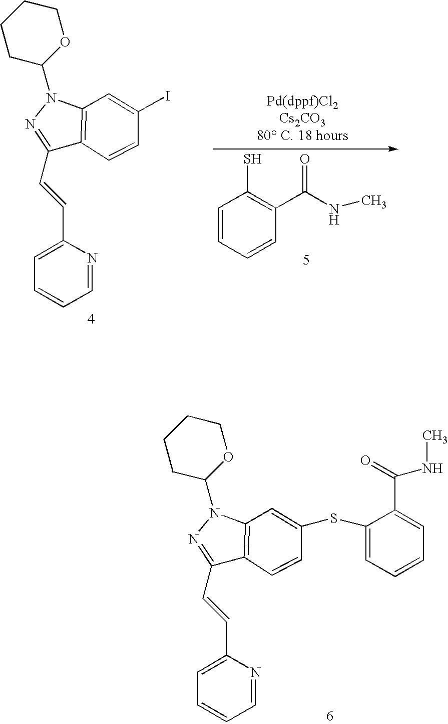

This chemical reaction is an intermediate step in a synthetic reaction scheme described in detail in a U.S. provisional patent application entitled Methods for Preparing Indazole Compounds, U.S. 60/624,575, filed on Nov. 2, 2004, which is incorporated herein by reference. The coupling reaction shown above uses a palladium catalyst to couple compounds 4 and 5. Because palladium was used in this reaction step, the resulting compound 6 was contaminated with palladium (865 ppm). The general treatment condition used to remove palladium involved stirring the crude residue of compound 6 with TMT-silica gel, followed by filtering through silica gel, then elution with DCM. The resulting compound was then evaporated and tested for residual palladium. Several different treatment conditions, using several different TMT-silica gels as prepared in Example 6 were used. The specific palladium treatment conditions used and the resulting palladium levels after treatment are shown in the table below.

| | | Palladium Content |
|---|---|---|
| TMT-Silica | | After Treatment |
| Gel Used | Treatment Conditions | (ppm) |
| Example 6-B | TMT-silica gel (5 wt. eq.); | <13 |
| | DCM (30 vol.), evaporated for | |
| | 18 hours at 23° C. | |
| Example 6-B | TMT-silica gel (1 wt. eq.); | 23 |
| | DCM (20 vol.), evaporated for | |
| | 18 hours at 23° C. | |
| Example 6-B | TMT-silica gel (3 wt. eq.); | <13 |
| | DCM (20 vol.), evaporated for | |
| | 18 hours at 23° C. | |
| Example 6-C | TMT-silica gel (3 wt. eq.); | 1.5 |
| | DCM (20 vol.), filtered through | |
| | silica gel, then evaporated for | |
| | 18 hours at 23° C. | |
| Example 6-D | TMT-silica gel (3 wt. eq.); | <6 |
| | DCM (20 vol.), filtered through | |
| | silica gel, then evaporated for | |
| | 18 hours at 23° C. | |
| Example 6-A | TMT-silica gel (3 wt. eq.); | 3 |
| | DCM (20 vol.), filtered through | |
| | silica gel, then evaporated for | |
| | 18 hours at 23° C. | |

### Example 8

### Palladium Removal Using TMT-Silica Gel

To further test the ability of the TMT-silica gels as described in Example 6, the palladium contaminated organic compound shown below was used.

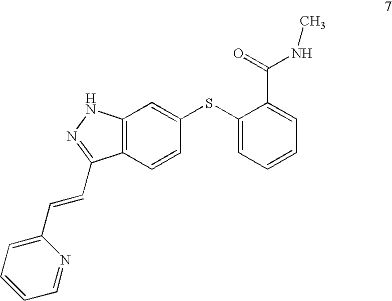

Synthetic routes to prepare compound 7 using palladium are described in detail in two U.S. provisional patent applications, both entitled Methods for Preparing Indazole Compounds, U.S. 60/624,635 and U.S. 60/624,575, both filed on Nov. 2, 2004, which are each incorporated herein by reference. The general treatment condition used to remove palladium involved stirring a solution of compound 7 with TMT-silica gel, followed by filtration through Celite™, followed by evaporation and precipitation to give compound 7 with reduced palladium levels. Because of the poor solubility of compound 7, different solvent systems were used and found to give different efficiencies in the removal of palladium. Several different treatment conditions, using several different TMT-silica gels as prepared in Example 6 were used. The specific palladium treatment conditions used and the resulting palladium levels after treatment are shown in the table below. In all cases, the palladium content before treatment was 1100 ppm.

| | | Palladium Content |
|---|---|---|
| TMT-Silica Gel | | After Treatment |
| Used | Treatment Conditions | (ppm) |
| Example 6-D | A solution in THF, water, and 2N HCl (2 eq.) was stirred for | 191 |
| | 18 hours with TMT-silica gel (3 wt. eq.), then filtered through | |
| | Celite ™ and evaporated. | |
| Example 6-D | A solution of acetic acid (5 vol.) was passed through a pad of | 192 |
| | TMT-silica gel (3 wt. eq.) over Celite ™. The pad was washed | |
| | with THF and the combined filtrate was evaporated leaving a | |
| | slurry of product in acetic acid. The product was filtered and | |
| | dried. | |
| Example 6-D | A solution of MeOH (5 vol.) and acetic acid (5 vol.) was | 6 |
| | passed through a pad of TMT-silica gel (3 wt. eq.) over | |
| | Celite ™. The pad was washed with MeOH and the combined | |
| | filtrate was evaporated then precipitated from toluene, filtered, | |
| | and dried. | |
| Example 6-D | A solution of MeOH (5 vol.) and acetic acid (5 vol.) was | 24 |
| | passed through a pad of TMT-silica gel (3 wt. eq.) over | |
| | Celite ™. The pad was washed with MeOH andn the | |
| | combined filtrate was evaporated, leaving acetic acid mixture, | |
| | filtered and dried. | |
| Example 6-D | A solution of water (5 vol.) and acetic acid (5 vol.) was stirred | 8.6 |
| | with TMT-silica gel (3 wt. eq.) then filtered over Celite ™. The | |
| | pad was washed with MeOH and the combined filtrate was | |
| | evaporated and dried. | |
| Example 6-D | A solution of water (5 vol.) and acetic acid (5 vol.) was stirred | 20 |
| | with TMT-silica gel (3 wt. eq.) then filtered over Celite ™. The | |
| | pad was washed with MeOH and the combined filtrate was | |
| | evaporated leaving acetic acid solution, then neutralized with | |
| | NaOH, then filtered and dried. | |
| Example 6-A | A solution of water (5 vol.) and acetic acid (5 vol.) was stirred | 6 |
| | with TMT-silica gel (3 wt. eq.) then filtered over Celite ™. The | |
| | pad was washed with MeOH and the combined filtrate was | |
| | evaporated then precipitated from xylenes, filtered and dried. | |

### Example 9

### Palladium Removal Using TMT-Silica Gel

To further test the ability of the TMT-silica gels as described in Example 6, the palladium contaminated (4900 ppm) organic compound 3, as described in Example 4, was used. A solution of compound 3 in THF was stirred for 18 hours with the TMT-silica gel (5 wt. eq.) as described in Example 6-B, then filtered through silica gel, eluted with THF, and evaporated. The resulting palladium level following this treatment was 176 ppm.

### Example 10

### Palladium Removal Tests

Several different palladium scavengers were compared for their ability to remove palladium. Compound 3 as discussed above in Example 4, was used in these tests. The initial level of palladium in a solution containing compound 3 was 6207 ppm. The palladium scavengers were prepared as discussed in the above Examples. In each case, 5 weight equivalents of the palladium scavenger was added to the palladium contaminated solution of compound 3 and stirred for 20 hours at room temperature. The Si-Thiol product is commercially available from Silicycle. The final palladium levels for each of the palladium scavengers are shown in the table below.

| | Palladium Content |
|---|---|
| Palladium Scavenger | Following Treatment (ppm) |
| 10% L-cysteine on silica alumina | 201 |
| 15% L-cysteine on silica alumina | 234 |
| 10% L-cysteine on silica gel | 324 |
| Si-Thiol (Silicycle) | 165, 217 |
| TMT-silica gel | 218 |

### Example 11

### Palladium Removal Using a Fixed Bed Reactor

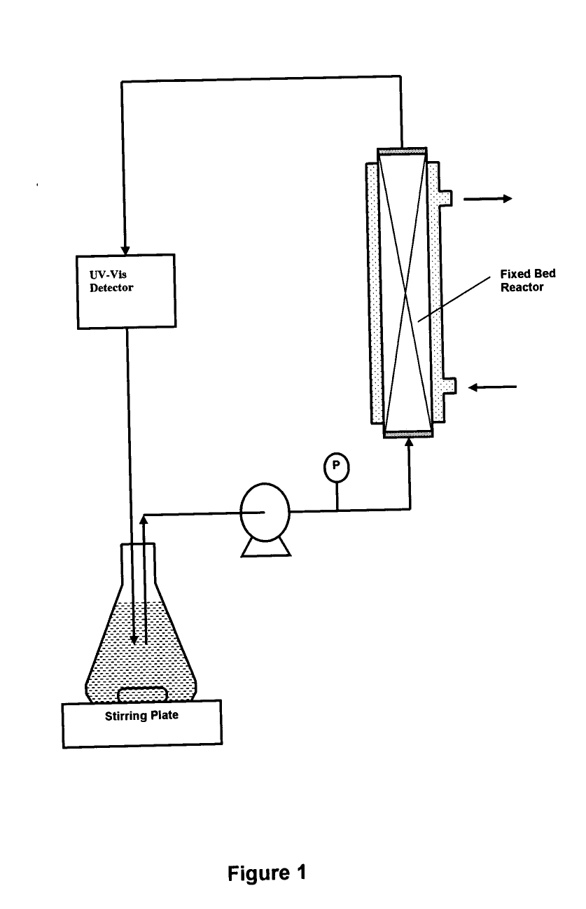

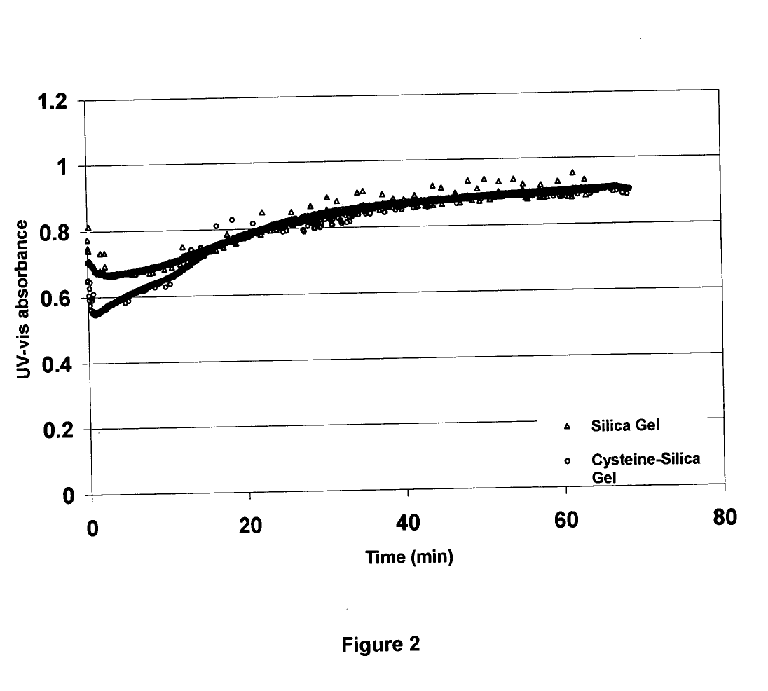

Due to the difficulty in handling the slurry when using a batch stirring procedure, and because the subsequent filtration is slow, a new method of treating a palladium contaminated solution using a fixed bed reactor was employed. Compound 3, described previously in Example 4, was used to test a palladium removal process using cysteine-adsorbed silica gel in a fixed bed reactor. After compound 3 was synthesized, the crude reaction mixture was filtered through filter paper and washed with THF (500 mL) to afford a dark solution. The filtered reaction mixture was diluted with 2L of THF to avoid solids precipitating out after palladium removal. Prior to treatment, the palladium content was 4170 ppm. The experimental setup for the palladium removal process using a fixed-bed reactor is shown in FIG. 1. The reservoir contained 80 mL of the reaction mixture. The fixed bed reactor was packed with cysteine-adsorbed silica gel in a column (1×15 cm). The column contained 7.4 g of cysteine-adsorbed silica gel (5 wt. eq. of compound 3 in every run). The fixed-bed reactor used in this experiment was a shell-and-tube type reactor that allowed for the passage of a cooling medium on the outside of the column, as shown FIG. 1. Typical pressure drop over the small scale column was in the range of 6 to 8 psi at a flow rate of 1 g/min. A UV-vis detector was used in some experiments to monitor the color change in the solution, where a wavelength of 700 nm was used. FIG. 2 shows a comparison of the UV-vis signal when passing solutions of constant concentration through plain silica gel (Merck 10810) and cysteine-adsorbed silica gel (cysteine adsorbed to Merck 10810 silica gel). The color change was not only caused by palladium removal, but also by dark-colored impurities removed by silica gel itself during the treatment process. The difference between the two curves in FIG. 2 is believed to show the kinetics of palladium removal by cysteine. It can be seen that palladium removal was rapid during the initial 10 minutes, but quickly slowed to almost undetectable rates. An explanation for thie initial rapid palladium-removal rate was that some cysteine was easily accessible (e.g. cysteine on the outer layer of the silica gel, or in the larger pores). After the easily accessible cysteine was consumed, the rate of palladium removal by cysteine-adsorbed silica gel was so slow that it was not easily detected. This observation suggests that the controlling step of this reaction was the diffusion of palladium-bonded molecules into the silica gel matrix.

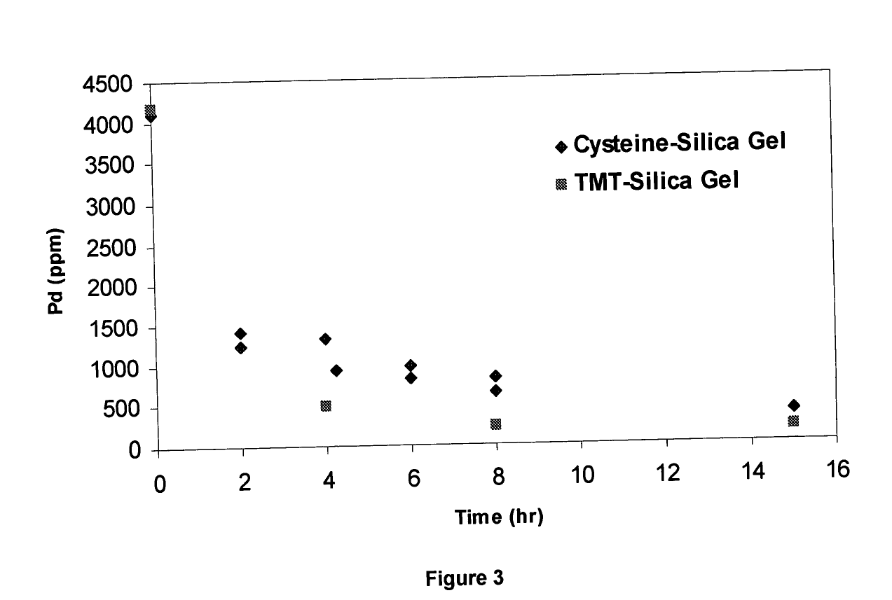

The profiles of palladium concentration as a function of recirculation time are shown in FIG. 3, in which the reaction mixture was pumped through a fixed bed reactor containing 5 wt. equivalents of cysteine-adsorbed silica gel. FIG. 3 indicates that the palladium concentration reduced sharply during the first two hours, after which the reduction rate slowed considerably. Further results are shown in the table below, which compares different operating conditions for the fixed bed reactor to the batch stirring process. The results of runs 1 and 2 indicate that the batch stirring process is comparable in effectiveness to the fixed bed for palladium removal. These results also indicate that doubling the amount of cysteine-adsorbed silica gel (run 3) or double treatment (run 4) reduced palladium concentration to the same level.

| | | Amount of | | Palladium |
|---|---|---|---|---|
| | | Cysteine-Adsorbed | | Content |
| Run | Process | Silica Gel (equiv.) | Time (hours) | (ppm) |
| 1 | Batch stirring | 5 | 15 | 352 |
| 2 | Fixed bed | 5 | 15 | 386 |
| 3 | Fixed bed | 10 | 15 | 167 |
| 4 | Fixed bed | 1^{st} 5 | 8 | 812 |
| | | 2^{nd} 5 | 8 | 158 |

We claim:

1. A composition comprising solid support media and cysteine adsorbed thereto.

2. The composition of claim 1, wherein the solid support media is selected from the group consisting of silica gel, silica alumina, alumina, clay, and carbon.

3. The composition of claim 1, wherein the composition comprises cysteine in an amount that is 0.01% or greater of the weight of the solid support media.

4. The composition of claim 1, wherein the composition comprises cysteine in an amount that is from 1% to 30% of the weight of the solid support media.

5. A composition comprising trimercaptotriazine (TMT) bound to silica gel.

6. The composition of claim 5, wherein TMT is bound to silica gel according to the following structure 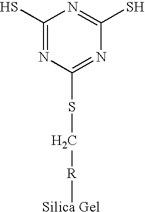
wherein R is C₁ to C₈ alkyl, C₂ to C₈ alkenyl, or C₂ to C₈ alkynyl.

7. The composition of claim 6, wherein the composition comprises TMT in an amount that is 0.01% or greater of the weight of the silica gel.

8. The composition of claim 6, wherein the composition comprises TMT in an amount that is from 10% to 70% of the weight of the silica gel.

9. A method for reducing the amount of at least one heavy metal in an organic phase, the method comprising contacting the organic phase with the composition of any of claims 1 to 8 to afford an organic phase wherein the amount of the at least one heavy metal is less than in the organic phase prior to contacting with said composition.

10. The method of claim 9, wherein the contacting step is carried out by batch stirring.

11. The method of claim 9, wherein the contacting step is carried out using a fixed bed reactor.
